(19) United States
(12) Patent Application Publication
(10) Pub. No.: US 2014/0029457 A1
(43) Pub. Date: Jan. 30, 2014

(54) COMMUNICATION DEVICE AND METHOD FOR REPORTING WIMAX PARAMETER

(71) Applicant: HON HAI PRECISION INDUSTRY CO., LTD., New Taipei (TW)

(72) Inventors: CHENG-YI HUANG, New Taipei (TW); HUNG-PEI CHOU, New Taipei (TW)

(21) Appl. No.: 13/944,870

(22) Filed: Jul. 17, 2013

(30) Foreign Application Priority Data
Jul. 30, 2012 (TW) 101127438

(51) Int. Cl. H04W 24/10

(52) U.S. Cl. CPC H04W 24/10
USPC 370/252

(57) ABSTRACT

A computerized method reports world interoperability for microwave access (WIMAX) parameters of a communication device to a network server. An initial value of each of the WIMAX parameters of the communication device is recorded in a file, the file having a predetermined format. When there is a change in a value of any WIMAX parameter, the data stored in the file is updated. When a parameter diagnosis command is received from the network server, the value of each of the WIMAX parameters stored in the file is reported to the network server through a network.

### BACKGROUND

1. Technical Field

Embodiments of the present disclosure relate to communication technologies of a worldwide interoperability for microwave access (WIMAX) network, and particularly to a communication device and a method for reporting WIMAX parameters of the communication device to a network server.

2. Description of Related Art

The Open mobile alliance device management (OMA-DM) is a device management protocol specified by the OMA-DM working group and the data synchronization (DS) working group for management of communication devices, such as mobile phones. Each communication device supporting the OMA-DM protocol has a management tree for managing WIMAX parameters of the communication device needed by a network server (e.g., OMA-DM server). The network server needs to obtain a value of each of the WIMAX parameters (e.g., channel bandwidth, RSSI, CINR) of the communication device to provide network services for the communication device. The network server obtains the value of each of the WIMAX parameters by sending a parameter diagnosis command to the communication device at regular intervals. In response to receiving the parameter diagnosis command, the communication device diagnoses the value of each of the WIMAX parameters of the communication device in sequence, and then reports the value of each WIMAX parameter to the network server. However, this method is time-consuming and inefficient, which may cause the communication device to not obtain the best services of the network server. Therefore, there is room for improvement in the art.

### BRIEF DESCRIPTION OF THE DRAWINGS

FIG. 1 is a schematic block diagram illustrating one embodiment of a communication device in communication with a network server.

FIG. 2 is a flowchart of one embodiment of a method for reporting WIMAX parameters of the communication device to the network server using a parameter reporting system of the communication device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

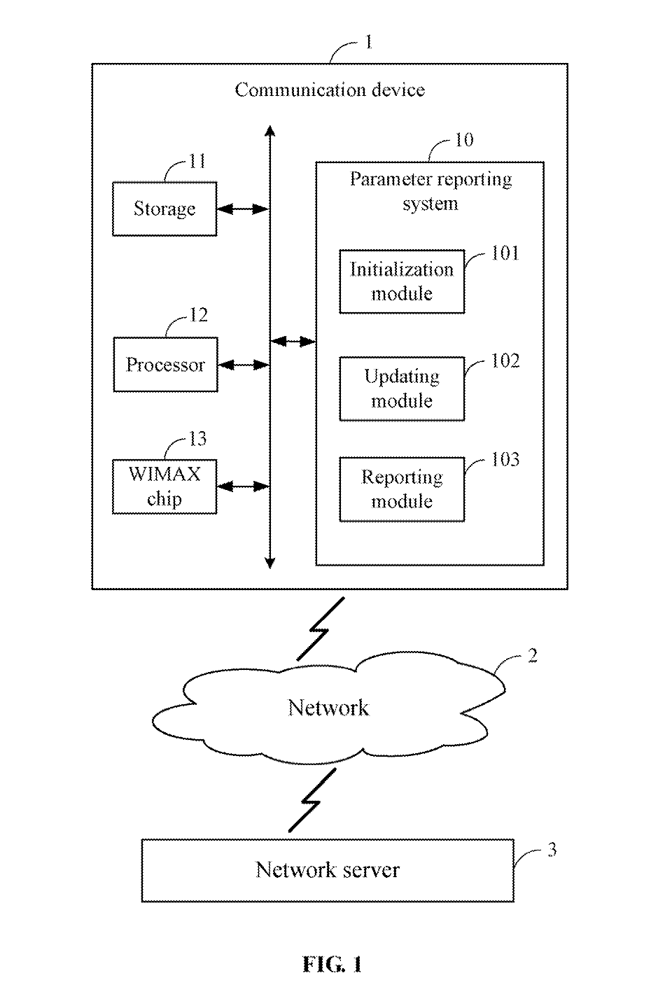

FIG. 1 is a schematic block diagram illustrating one embodiment of a communication device 1 in communication with a network server 3. The communication device 1 includes a parameter reporting system 10, a storage 11, a processor 12, and a worldwide interoperability for microwave access (WIMAX) chip 13. The communication device 1 communicates with the network server 3 via a network 2. In the embodiment, the communication device is a mobile communication device, such as a smart phone, a personal digital assistant (PDA), a mobile Internet device (MID), a palm top computer, or other similar devices. The network 2 is a wireless network. In the embodiment, the network 2 is a WIMAX network. The network server 3 may be, for example, an open mobile alliance device management (OMA-DM) server, which provides communication services for the communication device 1. The communication device 1 may be, for example, a smart mobile phone, a mobile Internet device, a tablet computer, or other similar mobile device. FIG. 1 shows one example of the communication device 1, and the communication device 1 can include more or fewer components than those shown in the embodiment, or have a different configuration of the components.

The parameter reporting system 10 may include a plurality of programs in the form of one or more computerized instructions executed by the processor 12 to perform operations of the communication device 1. In the embodiment, the parameter reporting system 10 includes an initialization module 101, an updating module 102, and a reporting module 103.

In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage devices. Some non-limiting examples of non-transitory computer-readable medium include CDs, DVDs, BLU-RAY, flash memory, and hard disk drives.

The initialization module 101 obtains a value of each of the WIMAX parameters of the communication device 1 from the WIMAX chip 13 when the communication device 1 is initialized and connected to the network 2, and records the obtained value of each of the WIMAX parameters in a file, the file having a predetermined format. In the embodiment, the file is pre-created and stored in the storage 11. The predetermined format may be, for example, a unified configuration interface (UCI) format. The WIMAX parameters of the communication device 1 include, for example, a channel bandwidth, an aerial gain, a maximum power of a power amplifier, a received signal strength indication (RSSI), a carrier to interference plus noise ratio (CINR), a downlink frequency, and other kinds of known network parameters indicating a communication quality of the communication device 1.

The updating module 102 detects, in real-time, a value of each of the WIMAX parameters of the communication device 1 using the WIMAX chip 13, and updates data stored in the file according to the detected value of each of the WIMAX parameters. In the embodiment, the updating module 102 detects whether or not the value of each of the WIMAX parameters changes. If a value of any WIMAX parameter changes, the updating module 102 updates the data stored in the file by recording the detected value of the changed WIMAX parameter in the file to replace the previous value of the changed WIMAX parameter. In one example, the updating module 102 sends a request to the WIMAX chip 13 at a first predetermined time interval to detect the value of each of the WIMAX parameters. Then, the updating module 102 compares the detected value of each WIMAX parameter with the corresponding values stored in the file to determine whether or not any value stored in the file changed.

The reporting module 103 receives a parameter diagnosis command from the network server 3, and reports the value of each of the WIMAX parameters stored in the file to the network server 3 through the network 2 in response to receiving the parameter diagnosis command. Thus, the network server 3 provides the communication services for the communication device 1 according to the reported value of each of the WIMAX parameters of the communication device 1. In the embodiment, the network server 3 sends the parameter diagnosis command to the communication device 1 at a second predetermined time interval. The second predetermined time interval is less than the first predetermined time interval.

As described above, when the parameter diagnosis command is sent to the communication device 1, the communication device 1 can directly report the stored data in the file to the network server 2 without detecting the value of each WIMAX parameter of the communication device 1. Therefore, it is not necessary for the communication device 1 to diagnose the value of each of the WIMAX parameters in sequence at the very time when the parameter diagnosis command is received. Thus, the time for reporting the value of each of the WIMAX parameters of the communication device 1 is greatly reduced, and the efficiency of reporting the value of each of the WIMAX parameters is improved.

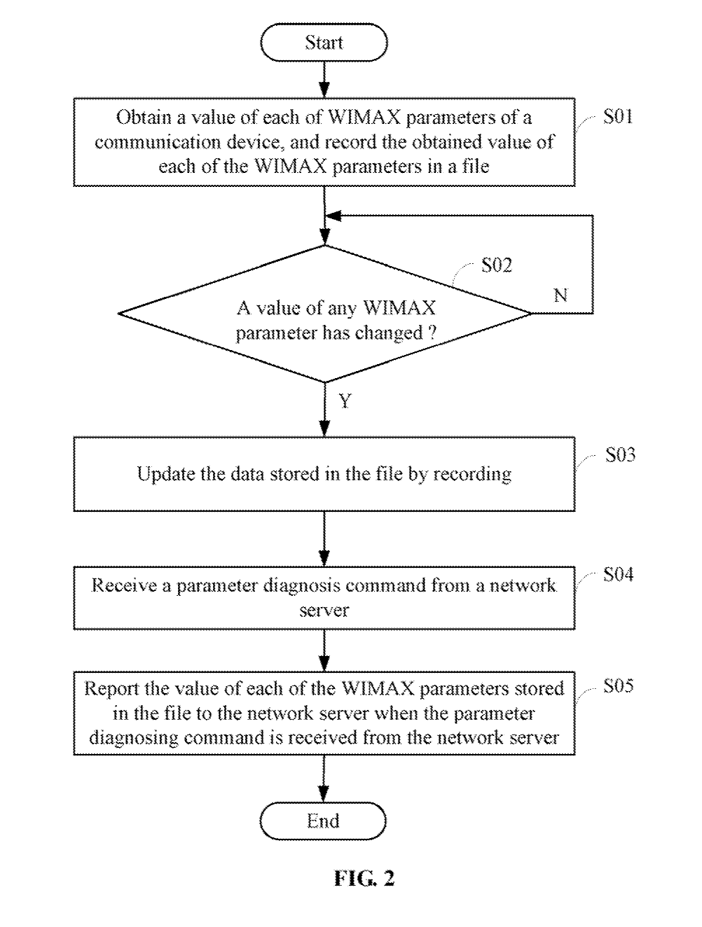

FIG. 2 shows a flowchart of one embodiment of a method for reporting WIMAX parameters of the communication device 1 to the network server 3 by using the parameter reporting system 10 of FIG. 1. Depending on the embodiment, additional steps may be added, others removed, and the ordering of the steps may be changed.

In step S01, when the communication device 1 is initialized and connected to the network 2, the initialization module 101 obtains a value of each of the WIMAX parameters of the communication device 1 from the WIMAX chip 13 and records the obtained value of each of the WIMAX parameters in a file having a predetermined format.

In step S02, the updating module 102 detects the value of each of the WIMAX parameters using the WIMAX chip 3 at a first predetermined time interval, and determines whether or not the value of any WIMAX parameter has changed. If a value of any WIMAX parameter has changed, the procedure goes to step S03. If the value of each of the WIMAX parameters does not change, step S02 is repeated.

In step S03, the updating module 102 updates the data stored in the file by recording the detected value of the changed WIMAX parameter in the file to replace the previous value of the changed WIMAX parameter.

In step S04, the reporting module 103 receives a parameter diagnosis command from the network server 3.

In step S05, when the diagnosis command is received from the network server 3, the reporting module reports the value of each of the WIMAX parameters stored in the file to the network server 3 through the network 2.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized method for reporting world interoperability for microwave access (WIMAX) parameters of a communication device to a network server, comprising:
obtaining a value of each of the WIMAX parameters of the communication device when the communication device is initialized and connected to a network;
recording the obtained value of each of the WIMAX parameters in a file, the file having a predetermined format;
detecting, in real-time, a value of each of the WIMAX parameters of the communication device using a WIMAX chip of the communication device, and determining whether or not a value of any WIMAX parameter changes;
updating data stored in the file according to the detected value of each of the WIMAX parameters, when a value of any WIMAX parameter changes; and
reporting the value of each of the WIMIX parameters stored in the file to the network server through the network when a parameter diagnosis command is received from the network server.

2. The method according to claim 1, wherein the value of each of the WIMAX parameters of the communication device is obtained from the WIMAX chip when the communication device is initialized and connected to a network.

3. The method according to claim 1, wherein the predetermined format is a unified configuration interface (UCI) format.

4. The method according to claim 1, wherein the data stored in the file is updated by recording the detected value of the changed WIMAX parameter in the file to replace the previous value of the changed WIMAX parameter stored in the file.

5. The method according to claim 2, wherein the detecting step comprises:
sending a request to the WIMAX chip at a first predetermined time interval, to detect the value of each of the WIMAX parameters.

6. The method according to claim 5, wherein the network server sends the parameter diagnosis command to the communication device through the network at a second predetermined time interval.

7. The method according to claim 6, wherein the second predetermined time interval is less than the first predetermined time interval.

8. The method according to claim 1, wherein the WIMAX parameters of the communication device are network parameters indicating a communication quality of the communication device.

9. The method according to claim 8, wherein the WIMAX parameters comprise a channel bandwidth, an aerial gain, a maximum power of a power amplifier, a received signal strength indication (RSSI), a carrier to interference plus noise ratio (CINR), and a downlink frequency, of the communication device.

10. A communication device communicating with a network server, comprising:
A WIMAX chip;
a processor;
a storage;
one or more programs stored in the storage and executed by the processor to perform a method of:
obtaining a value of each of the WIMAX parameters of the communication device when the communication device is initialized and connected to a network;
recording the obtained value of each of the WIMAX parameters in a file, the file having a predetermined format;
detecting in real-time a value of each of the WIMAX parameters of the communication device using the WIMAX chip, and determining whether or not a value of any WIMAX parameter changes;
updating data stored in the file according to the detected value of each of the WIMAX parameters, when a value of any WIMAX parameter changes; and
reporting the value of each of the WIMIX parameters stored in the file to the network server through the network when a parameter diagnosis command is received from the network server.

11. The communication device according to claim 10, wherein the value of each of the WIMAX parameters of the communication device is obtained from the WIMAX chip.

12. The communication device according to claim 10, wherein the predetermined format is a unified configuration interface (UCI) format.

13. The communication device according to claim 10, wherein the data stored in the file is updated by recording the detected value of the changed WIMAX parameter in the file to replace the previous value of the changed WIMAX parameter.

14. The communication device according to claim 11, wherein the detecting step comprises:
sending a request to the WIMAX chip at a first predetermined time interval, to detect the value of each of the WIMAX parameters.

15. The communication device according to claim 14, wherein the network server sends the parameter diagnosis command to the communication device through the network at a second predetermined time interval.

16. The communication device according to claim 15, wherein the second predetermined time interval is less than the first predetermined time interval.

17. The communication device according to claim 10, wherein the WIMAX parameters of the communication device are network parameters indicating a communication quality of the communication device.

18. The communication device according to claim 17, wherein the WIMAX parameters comprise a channel bandwidth, an aerial gain, a maximum power of a power amplifier, a received signal strength indication (RSSI), a carrier to interference plus noise ratio (CINR), and a downlink frequency, of the communication device.
